(19) United States
(12) Patent Application Publication
(10) Pub. No.: US 2008/0027800 A1
(43) Pub. Date: Jan. 31, 2008

(54) Method and apparatus for selecting related terms for electronic advertising

(76) Inventors: Yves Schabes, Newton, MA (US); Emmanuel Roche, Belmont, MA (US)

Correspondence Address: CHOATE, HALL & STEWART LLP, TWO INTERNATIONAL PLACE, BOSTON, MA, 02110, US

(21) Appl. No.: 11/495,949

(22) Filed: Jul. 28, 2006

(51) Int. Cl. G06Q 30/00

(52) U.S. Cl. 705/14

(57) ABSTRACT

Described are techniques used suggesting alternative terms to an advertiser which are associated with an advertisement. The advertiser issues a request including one or more initial advertisement terms to an advertisement publication system. In response to the request, the advertisement publication system provides a list of suggested alternatives to the one or more initial advertisement terms. The advertiser may select a term from the suggested alternatives to be associated with the advertisement. The term selected affects when the electronic advertisement is displayed to a subsequent user. As part of determining the suggested alternatives, the advertisement publication system: obtains a list of documents including the initial advertisement terms and the categories associated with the documents, ranks the categories, and presents a portion of the categories as the suggested alternatives.

### FIELD OF THE INVENTION

The present invention generally relates to computer systems, and more particularly to electronic advertising and selecting terms associated with display of an advertisement.

### BACKGROUND OF THE INVENTION

With the increased use of the Internet, many different forms of traditional services have also been implemented for use in connection with computer systems. Advertising is one such example. A user visiting an Internet site, for example, may find electronic advertisements being displayed in response to a request or user query. Any one or more of a variety of different techniques may be used in connection with electronic advertising, such as a targeting advertisements based on some user input or other information. Some websites, such as those providing a service like the traditional phone book yellow pages, may display advertisements for different business services and products in connection with a user search query. Some websites may also display advertisements in response to certain web pages or content examined by a user at a site. A vendor or advertiser may purchase an advertisement from the Internet site to have its advertisement associated with one or more terms such that, for example, the advertisement may be displayed when the user search query includes certain terms.

The Internet site may offer an on-line registration process in which the advertiser purchases an advertisement. The advertiser may register an advertisement which is associated with one or more terms controlling when the advertisement may be displayed to a user. Part of the registration process includes the advertiser specifying which particular one or more terms are associated with their advertisement. One of the problems that an advertiser may experience is selecting the foregoing one or more terms associated with the advertisement. For example, an advertiser may be selling a very specific service or product, such as “swimming pools”. If the advertiser elects to have their advertisement displayed only when the user enters exactly this particular combination of terms, the advertiser may not get a sufficient number of advertisements displayed because not very many users may enter this exact search query. It may be desirable to have tools and techniques which assist the advertiser in making the selection of one or more terms associated with an advertisement. It may also be desirable that the foregoing operate efficiently and dynamically in real-time for use in on-line advertising. It may be desirable that the foregoing provide more general suggestions with some form of ranking to an advertiser looking to increase the number of advertisements displayed.

### SUMMARY OF THE INVENTION

According to a first aspect, the invention is a method for selecting at least one term associated with display of an electronic advertisement, including obtaining an initial search term and obtaining a resultant set of one or more documents including the initial search term and categories associated with each of the documents in the resultant set. A portion of the categories is displayed as possible candidates for the at least one term associated with display of the electronic advertisement. In a preferred embodiment, the method includes searching a plurality of documents for an initial search term producing the resultant set. The search may be performed using a query tool. In a preferred embodiment, the query tool is located at a first network location and the obtaining an initial search term, the obtaining a resultant set, and the displaying a portion of the categories, are preformed in response to a request received at a second network location different from the first network location. In this embodiment, the method may further include categorizing the resultant set of documents. In one embodiment, the categorizing is performed using at least one of an automatic categorization tool located at a first network location and the obtaining an initial search term, the obtaining a resultant set, and the displaying a portion of the categories are performed in response to a request received at the first network location.

In yet another aspect, the invention is method for selecting at least one term associated with an electronic advertisement including issuing a request from a first computer to an advertisement publication system, the request including one or more initial advertisement terms, and providing to the first computer by the advertisement publication system, a list of suggested alternatives to the one or more initial advertisement terms. At least one term from the suggested alternatives, to be associated with the advertisement, is selected, wherein display of the electronic advertising is determined in accordance with at least one term selected. In a preferred embodiment, the method, according to this aspect of the invention, further includes determining the suggested alternatives. In this embodiment, the method further comprises performing, by the advertisement publication system, the obtaining of a list of documents including the initial advertisement terms and the categories associated with the documents, and ranking the categories. A portion of the categories, as suggested alternatives, is then selected.

### BRIEF DESCRIPTION OF THE DRAWING

Features and advantages of the present invention will become more apparent from the following detailed description of exemplary embodiments thereof taken in conjunction with the accompanying drawings in which:

FIG. 1 is a block diagram of an embodiment of a computer system used in the invention disclosed herein;

FIG. 2 is a block diagram of components included in one embodiment of the computer system of FIG. 1;

FIG. 3 is a block diagram of components that may be included in one embodiment of the query server system of FIG. 1;

FIG. 4 is a block diagram of components that may be included in one embodiment of the advertisement publication system of FIG. 1;

FIG. 5 is a block diagram of components that may be included in another embodiment of the advertisement publication system of FIG. 1;

FIG. 6 is an illustration of an embodiment of a hierarchical category tree;

FIG. 7 is an example of an embodiment of a non-hierarchical category structure;

FIG. 8 is an example of an embodiment of a portion of the tree from FIG. 6 with associated counts; and

FIG. 9 is a flowchart of method steps of one embodiment for providing alternative term suggestions to an advertiser.

### DETAILED DESCRIPTION OF PREFERRED EMBODIMENTS

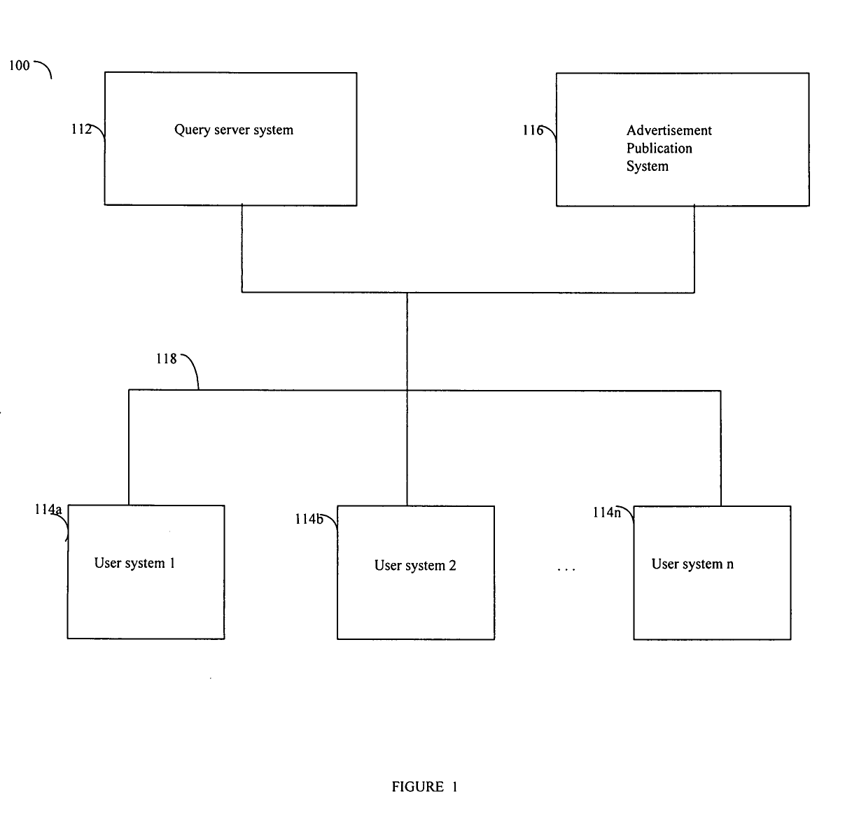

Referring now to FIG. 1, shown is an example of an embodiment of a computer system according to the present invention. The computer system 100 includes a query server system 112, user systems 114a-114n and advertisement publication system 116 connected through communication medium 118. In this embodiment of the computer system 100, the N user systems 114a- 114n, the query server 112 and the advertisement publication system 116 may communicate, for example, in performing input/output (I/O) operations or data requests. The communication medium 118 may be any one of a variety of networks or other type of communication connections as known to those skilled in the art. The communication medium 118 may be a network connection, bus, and/or other type of data link, such as a hardwire or other connections known in the art. For example, the communication medium 118 may be the Internet, an intranet, network, non-network or other connection(s) by which the user systems 114a-114n, the query server system 112 and the advertisement publication system 116 may communicate with each other as well as others included in the computer system 100.

Each of the user systems 114a-114n, the advertisement publication system 116, and the query server system 112 included in the computer system 100 may be connected to the communication medium 118 by any one of a variety of connections as may be provided and supported in accordance with the type of communication medium 118. The processors included in the user computer systems 114a-114n, the advertisement publication system 116, and the query server system 112 may be one or more of proprietary or commercially-available, single or multi-processor systems, such as an Intel-based processor, IBM mainframe or other type of commercially available processor able to support incoming traffic in accordance with each particular embodiment and application.

It should be noted that the particulars of the hardware and software that may be included in an embodiment of the user systems 114a-114n, the advertisement publication system 116, and the query server system 112 are described herein in more detail. However, the particulars may vary in accordance with each embodiment. Each of the user computers 114a-114n, the advertisement publication system 116, as well as the query server system 112, may all be located at the same physical site, or, alternatively, may also be located in different physical locations. The communication medium that may be used to provide the different types of connections between the user computer systems and the query server system of the computer system 100 may use any one or more of a variety of different communication protocols such as SCSI, ESCON, Fibre Channel, or GIGE (Gigabit Ethernet), and the like. Some or all of the connections by which the user systems 114a-114n, the advertisement publication system 116, and the query server system 112 may be connected to the communication medium 118 may pass through other communication devices, such as switching equipment that may exist such as a phone line, a repeater, a multiplexer or even a satellite.

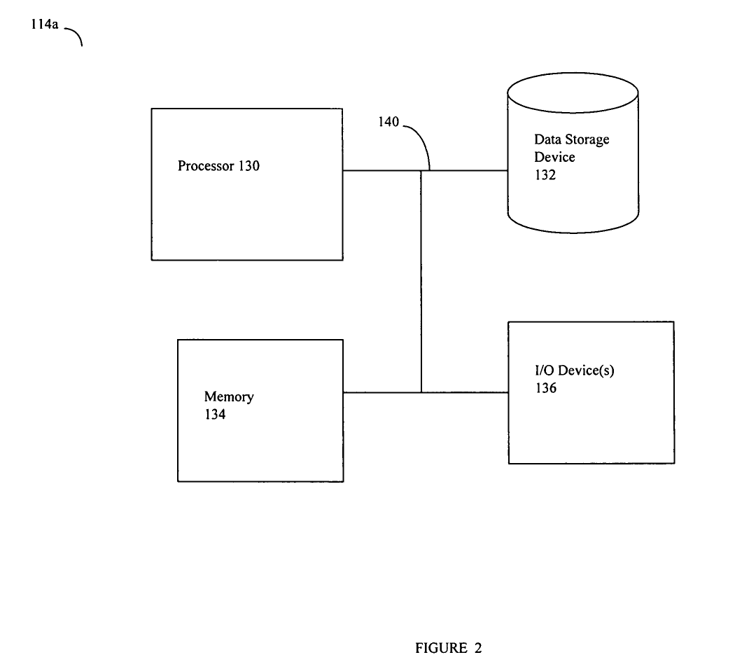

Referring now to FIG. 2, shown is an example of components that may be included in one embodiment of the user system 114a. It should be noted that although a particular user system is described herein, other user systems 114b-114n may also be similarly configured. Additionally, it should be noted that each user system 114a-114n may have any one of a variety of different configurations including different hardware and/or software components. Included in this embodiment of the user system 114a is a processor 130, a memory, 134, one or more I/O devices 136 and one or more data storage devices 132. Each of the foregoing may communicate using a bus 140. Each of the components and the bus may be any one of more of a variety of different components in accordance with the parameters of the particular user system 114a.

In one example, a graphical user interface (GUI) may be displayed on an output device of the user system 114a, such as a terminal with a display screen. A user may input data, such as in connection with a request to the advertisement publication system to purchase an advertisement or perform a data query on the query server system, using a keyboard and/or mouse. The user data may be communicated to the appropriate destination over the connection 118, such as, for example, a user's data query may be communicated to the query server system 112 over the connection 118 which may be the Internet. Results may be communicated from the query server system to the user system 114a and displayed on an output device of the user system 114a.

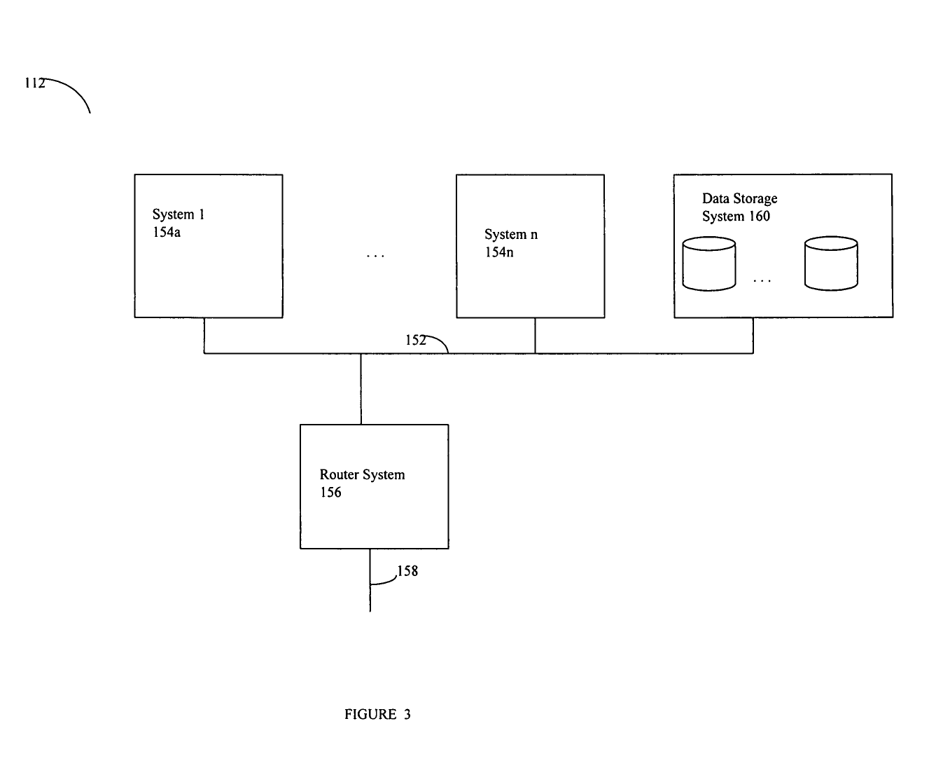

Referring now to FIG. 3, shown is an example of components that may be included in one embodiment of the query server system 112. In this example, the query server 112 may include one or more computer systems 154a-154n, a data storage system 160 and a router system 156. The computer systems 154a-154n and the router system 156 may include one or more processors that process the actual data queries by executing instructions residing thereon. An incoming data query may be received through connection 158 and forwarded to the router system 156. The router system 156 may forward the request further to one or more of the systems 154a-154n for processing. The router and the systems 154a-154n may communicate with each other and the data storage system 160 over the communication connection 152. The data storage system 160 may include one or more data storage devices, for example, such as disks. The router may use any one or more different techniques in determining which system(s) process an incoming request.

As with the user system 114a, the query server system 112 and the advertisement publication system 116, described in more detail in following paragraphs, may be any one of variety of different configurations of hardware and/or software components determined in accordance with the parameters of the particular server system. For example, a server system embodiment may not include a router and may include only a single system, such as computer system 154a connected to data storage 160.

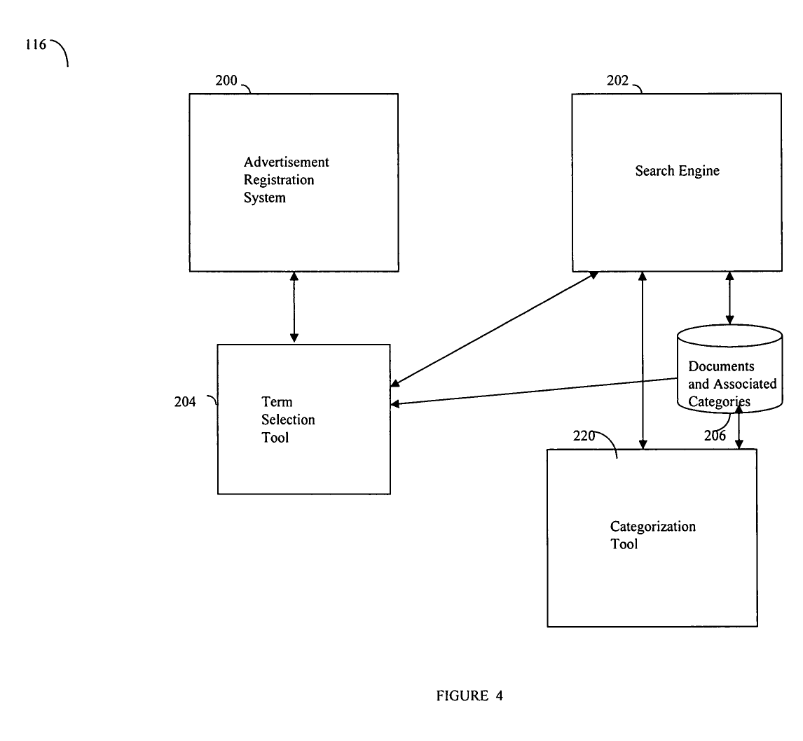

Referring now to FIG. 4, shown is an example of components that may be included in one embodiment of the advertisement publication system 116. It should be noted that each of the components described in connection with the advertisement publication system 116 of FIG. 4 may be implemented using software and software-related tools as known to those skilled in the art to produce instructions for execution by one or more processors included within the advertisement publication system 116.

It should be noted that the particular hardware and/or software components included in an embodiment of the advertisement publication system 116 may vary in accordance with each embodiment. For example, one embodiment of the advertisement publication system 116 may include a hardware configuration similar to that as described in connection with the query server system 112 of FIG. 3. Specifically, the advertisement publication system 116 may include a router system and one or more other server systems as well as a data storage system. Similar to the query server system 112, the router within the advertisement publication system 116 may further forward an incoming request to one or more particular systems for processing. In another embodiment, the advertisement publication system 116 may include a simpler hardware configuration, for example, as described in connection with the user system 114a of FIG. 2. The particular hardware and/or software configurations of any of the systems described herein, such as the user systems, the query server system, and the advertisement publication system, may vary in accordance with each embodiment, the anticipated usage, and other system parameters. The particular embodiments described herein are for purposes of illustration and should not be construed as a limitation of any of the techniques described herein.

Referring still to FIG. 4, the advertisement publication system 116 includes an advertisement registration system 200, a term selection tool 204, a search engine 202, and documents and associated categories 206. It should be noted that the particular components described in connection with FIG. 4 are those used in connection with illustrating the techniques described herein. An embodiment of the advertisement publication system 116 may also include other hardware and/or software components than as described herein.

The advertisement registration system 200 is used in connection with registering an advertiser who is interested in purchasing an advertisement for display. In one embodiment, the advertiser or vendor may issue a request, such as from a user system 114a, over communication medium 118 to the advertisement publication system 116. The communication medium 118 used may be the Internet. The user system 114a may be executing a browser which issues a request over the Internet to the advertising publication system 116. In this example, the advertisement registration system 200 may respond by sending one or more HTML pages for display at the user's system 114a. The HTML pages may include a data entry form interface including a request for one or more fields of information for registration as an advertiser on the advertisement publication system 116. One of the requested pieces of information or data that may be entered through the user system 114a with the web browser includes one or more advertisement terms to be associated with the advertisement. The one or more advertisement terms may be used by the vendor to describe the particular service or product for which an advertisement is being purchased. The advertisement may later be displayed to a user.

In the embodiments described herein, the advertisement may be displayed to a subsequent user as a pop-up electronic advertisement in which the user makes no purposeful actions to solicit the advertisement. In this example, an advertiser may have selected one or more terms that are associated with the advertisement and related to when the advertisement is displayed. The user may be visiting an Internet site and enter one or more data items that may include the one or more terms, or may be determined by the Internet site to be related to the one or more terms. In response, the Internet site may utilize targeted electronic advertising techniques and display the advertisement to the user. In another example, a user may be visiting an Internet site, for example, to look for a restaurant in a particular location. The user may enter information, such as a particular restaurant type ( e.g., Italian, Chinese, and the like), and a location (e.g., city and state). In response, the website may provide a list of restaurants and possibly an associated electronic advertisement. The advertiser may have previously selected, for example, to have their advertisement associated with the particular restaurant type which may be included in the user-specified information, or otherwise may be determined as related to the previously selected advertisement terms.

Once the advertiser has entered all of the data, the data including the one or more advertisement terms is sent over the Internet 118 to the advertisement registration system 200. The advertisement registration system 200 interacts with the term selection tool 204 to provide a list of one or more alternative suggestions to the one or more advertisement terms. These alternative suggestions may include other terms providing a broader classification within which the advertiser entered terms are included. Thus, the advertisement may be displayed to a larger number of users. The alternative suggestions may also include synonyms or related terms.

In one embodiment, an advertiser may optionally elect to have the term selection tool 204 provide one or more alternative suggestions based on the one or more advertisement terms by selecting an option provided in the data entry form. For example, the advertiser may realize that they have a very specific product or service. The advertiser may know that a very small number of user queries or user data items may contain the actual or identical terms entered by the advertiser. The advertiser wishes to have the advertisement displayed a larger number of times and may seek alternative, broader terms that may be entered by more users. The advertiser may also be seeking different wording to describe their particular product or service and may also be looking to have their advertisement displayed in response to user queries that do not necessarily include broader terms, but rather may include synonyms for those one or more advertisement terms. For example, an advertiser may wish to purchase an advertisement for a sandwich business. The advertiser may also want to have the advertisement associated with the synonyms or related terms “hero”, “submarine” and “hoagie”. Alternatively, the advertiser may want the advertisement associated with broader terms, such as “catering”, rather than terms that may be characterized as synonyms.

It should be noted that the advertisement publication system 116 may be one component included at an Internet site, for example, such as an Internet site at which a user may look for a restaurant, a type of service, or a product similar to the way one may use a phone book. However, it should be noted that techniques described herein are not limited for use with this type of service or system and maybe used in connection with any type of electronic advertisement system.

In response to the advertiser requesting alternative suggestions to the particular terms entered, the term selection tool may interact with the search engine 202 to provide a list of alternative suggestions. In this embodiment, the term selection tool 204 invokes the search engine 202 with the advertiser supplied term or terms. The search engine 202 searches one or more documents for the advertiser's terms. In this example of FIG. 4, the documents may be stored on a data storage device or within a data storage system as represented by the element 206. The documents, for example, may be web pages or other types of indexed electronic documents in one embodiment.

The search engine 202 returns a predetermined number of documents that include the advertiser's entered terms. The particular number of documents selected may vary in accordance with each embodiment and may also be entered as part of the advertiser information using a user interface. After the search engine 202 has determined the one or more documents that include the terms specified by the advertiser, the search engine 202 invokes a categorization tool 220 to determine the one or more categories associated with each of the documents selected by the search engine 202 as including the terms entered by the advertiser.

It should be noted that the categorization tool 220 included in one embodiment may be characterized as an automatic categorization tool which performs dynamic or on-the-fly categorization as part of processing the advertiser's request. In other words, the categorization may happen as a real time processing step, for example, while the advertiser is waiting at his or her terminal or other display device for a list of the alternative suggestions. As known in the art, there are any one of a variety of automatic categorization techniques that may be used.

It should be noted that the search engine 202 may utilize any one of the variety of different searching techniques. Additionally, it should be noted that the search engine 202 may be a third party search engine. The advertisement publication system 116 may subscribe and use the services of the search engine 202 of the third party. This search engine may be included at the same site as the advertisement publication system 116, or alternatively, may be included at an alternate Internet site such as the query server system 112. For example, in one embodiment, the advertisement publication system 116 may subscribe to the searching services of Google™, Alta Vista™, and the like.

In this embodiment, the search engine 202 may be located at the same site or on the same system as the advertisement publication system 116. In the example embodiment of FIG. 4, the advertisement publication system 116 includes its own search engine 202 which provides as an output the list of documents as an input to the categorization tool 220. The documents themselves may be used by the categorization tool 220 to produce a list of associated categories for each of the documents. In this embodiment, the documents as well as their associated categories may be stored in a structure of element 206.

In another embodiment, the documents may be stored in a database, such as a commercial database, and the query interface provided by this database may be used in connection with performing the search for the advertiser's terms.

The term selection tool 204 may then use as an input the documents and a list of the associated categories to provide a list of alternative suggested terms to the advertiser. The particular techniques in one embodiment that may be used in connection with producing this list of alternative suggestions using the categories are described in more detail in following paragraphs.

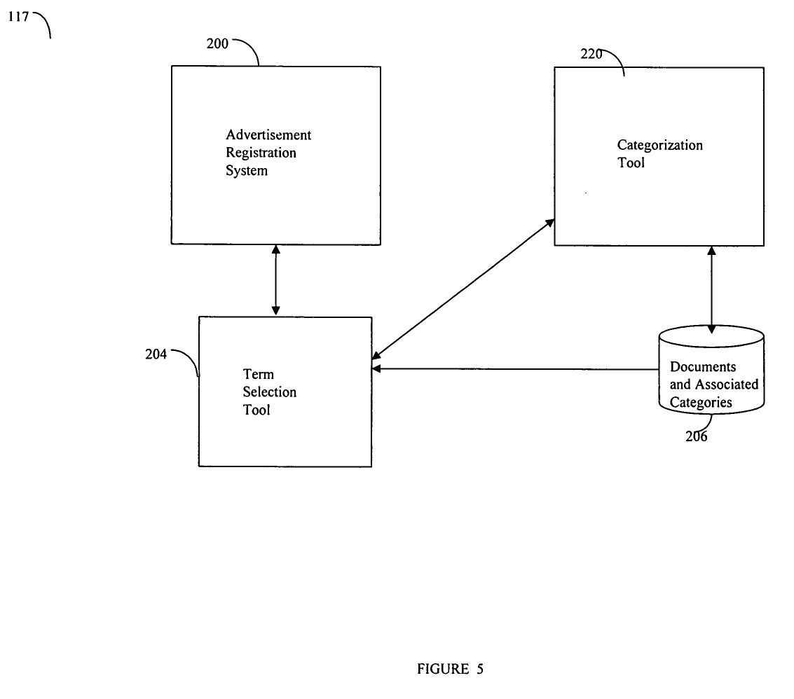

Referring now to FIG. 5, shown is an alternative embodiment of the advertisement publication system. This alternative embodiment of the advertising publication system 117 does not include a search engine 202 located at, or as a component of, the advertisement publication system 116. As an alternative, the advertisement publication system 116 may subscribe to the services of the query server system 112. In other words, the advertisement publication system 116 may issue a query of the query server system 116 based on the advertiser's supplied terms. The query server system 112, in response, may send one or more documents and/or a list thereof including the advertiser terms to the advertisement publication system 116 as a response. These particular documents may be stored in element 206 of FIG. 5. It should be noted that advertisement publication system 116 may issue a query request of the query server system 112 similar to the way a user may enter a query to a service, such as Google, Alta Vista, and the like, over the Internet. The advertisement publication system does not have any special partnering arrangements with the query server system 112 in this particular example.

Alternatively, the advertisement publication system 116 may have a particular partnering or other type of relationship with the query server system 112 in which the advertisement publication system 116 also subscribes to the query services of the query server system 112. In the event that the advertisement publication system 116 has partnering or another special relationship with the query server system 112, the advertisement publication system 116 may also be able to obtain a list of associated categories such that the process of determining the categories associated with each of the documents is also performed by the query server system 112. The query server system 112 may provide to the advertisement publication systems the actual documents, as well as the associated categories for each of the documents. Alternatively, if the advertisement publication system, for example, does not have a partnering or other special relationship with the query server system 112, the query server system 112 may return to the advertisement publication system the documents including the advertiser's terms. Then, the categorization of those documents may be performed by the categorization tool 220 included in the advertisement publication system 116. The associated categories determined for each of the documents 206 and used as input to the term selection tool 204 are produced as an output of the categorization tool 220 of FIG. 5.

It should be noted that the foregoing categorization of documents may be performed dynamically in response to the advertiser's request. Alternatively, an embodiment, such as the embodiment of the advertisement publication system 116 described in connection with FIG. 4, may perform categorization at some point prior to the advertiser purchasing the advertisement. In other words, an embodiment may also perform categorization as an offline or preprocessing step such that categorization is not done in real time while the advertiser is waiting for a list of suggested or alternative terms. For example, if an embodiment of the advertisement publication system 116 has a list of documents which are searched for the advertiser's terms, the categories associated with each of the documents may be determined prior to the advertiser registering for an advertisement purchase. Sometime later, the advertiser may enter the request to purchase an advertisement and additionally make a request for alternative suggested terms. At this point, the search engine searches the list of documents for the advertiser supplied terms. However, the categories have been determined beforehand.

In the embodiments described herein, the categorization of each of the documents may be determined using the categorization tool 220. Alternatively, the categorization of each of the documents may also be performed manually or some combination of manual and/or automatic. Additionally, an embodiment may choose to perform some or all of the categorization as a pre-processing or offline processing step rather than at the time the advertiser makes a request for alternative term suggestions. This may vary in accordance with each embodiment.

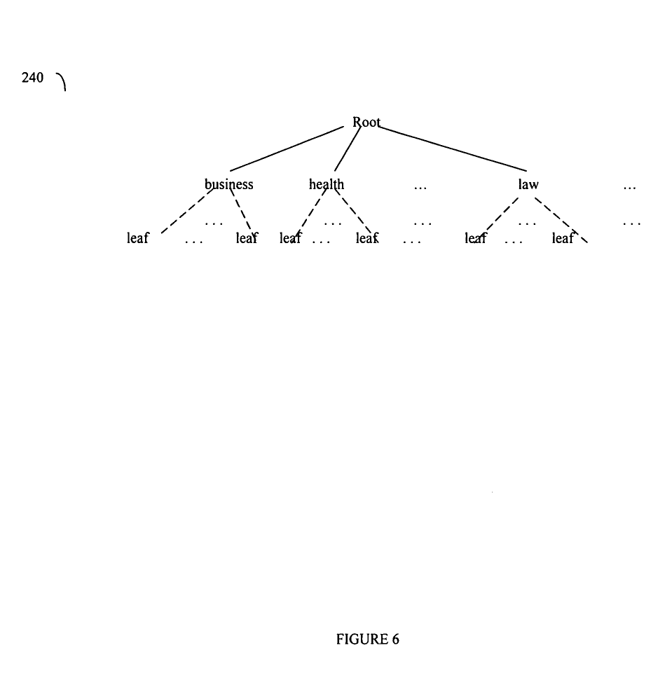

Referring now to FIG. 6, shown is an example of an embodiment of a category tree structure. It should be noted that the tree structure 240 is only one example of an embodiment of how the categories may be represented. The example 240 is an n-ary tree structure in which each non-leaf parent node may have one or more child nodes. The tree structure that includes the categories may be used, for example, in connection with the automatic categorization techniques as may be performed by the categorization tool described elsewhere herein. Alternatively, the categories may be stored or represented in a flat structure.

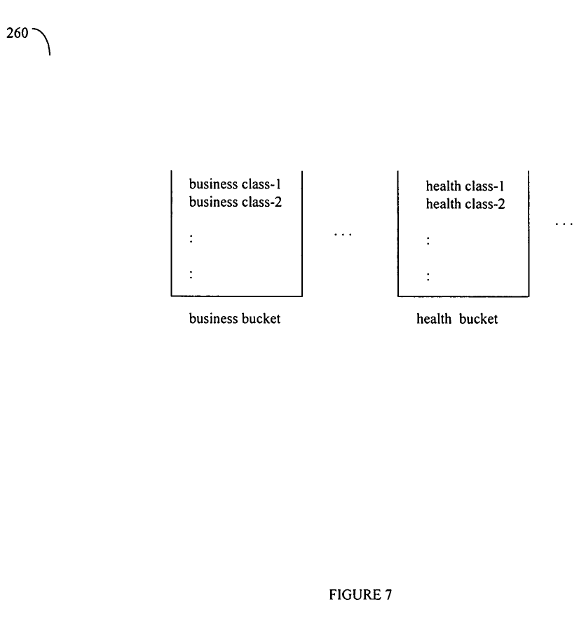

Referring now to FIG. 7, shown is an alternative embodiment of a representation 260 of the categories that may be used in connection with performing categorization. In the representation 260, each general category or class may be represented as a bucket of one or more other related terms. The alternative representation 260 provides a flat or non-hierarchical structure of categories. If it is determined that a document is classified as being in a particular category, such as the business category, each of the classes included in that bucket, such as the business bucket, may be associated as a category with that document.

It should be noted that any one of the variety of different data structures and representations, as well as any one of the variety of different automatic and/or manual categorization techniques, may be used. The representations of FIG. 6 and FIG. 7 are illustrations of two ways of representing and structuring the categories. FIG. 6 includes a hierarchical type of arrangement 240 in which the data structure may be represented as a tree structure. Alternatively, an embodiment may use a non-hierarchical or flat arrangement of the categories, or any other type of arrangement as known to those of ordinary skill in the art. The particular structure for the categories may vary in accordance with each embodiment and may depend on the technique used in categorizing the documents.

What has been described are a variety of different techniques that may be used in obtaining a list of documents and their associated categories. Once this has been determined, term selection tool 204 may begin processing to determine a list of relevant categories which may be supplied to the advertiser as alternative term suggestions. It should be noted that the advertiser may select a particular quantity of alternative terms to be supplied. Alternatively, a default number of suggested alternative terms may be displayed to the advertiser. Similarly, other parameters, such as the number of documents used in the query, may rely on an advertiser supplied value for the parameter, or a default value.

It should be noted that the term selection tool may use any one of a variety of different techniques in ranking the categories. What will now be described is one particular technique that may be used in connection with ranking the categories to determine a weighted relevancy metric based on the number of documents retrieved which include a specific category. The relevancy metric for each category may be represented as:

COUNT*SPECIFICITY

where the COUNT may be determined by counting the number of documents retrieved which include a specific category. How SPECIFICITY may be determined is described in more detail in following paragraphs.

It should be noted that an embodiment may also rank categories using other metrics, such as only using the COUNT described above.

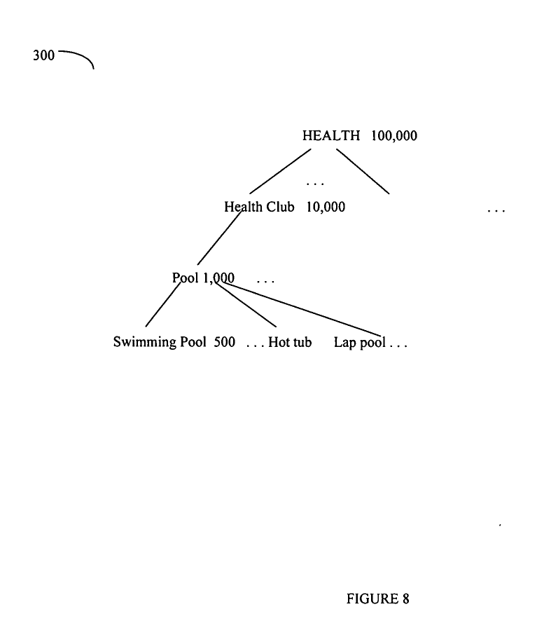

Referring now to FIG. 8, shown is a representation of one branch or subtree 300 of the category tree structure 240 previously described in connection with FIG. 6. What will now be described is one embodiment for determining the SPECIFICITY or weighted value for a particular category. As previously shown in the tree structure 240 of FIG. 6, each category has a relationship hierarchically to another category. Within the tree structure, a specificity or weighted value may be determined for each of the categories. In the representation 300, shown is a frequency count of the number of documents that include the associated category. For example, 100,000 documents have the associated category of HEALTH. Ten thousand documents have the associated category of HEALTH CLUB. One thousand documents have the associated category of POOL. Five hundred documents have the associated category of SWIMMING POOL. In the representation 300, HEALTH CLUB is a child of the node HEALTH such that HEALTH CLUB is considered a narrower classification of HEALTH. Similarly, when tracing from the root node to the leaf nodes and from parent to children, the categories get narrower or more specific. The SPECIFICITY factor may be represented as:

1/log(count)

where “log” is the mathematical logarithm of the count as indicated in the representation 300. Alternatively, an embodiment may use a SPECIFICITY which is a weighted value of a ratio in which the numerator of this ratio is the count associated with each category. The denominator may be, for example, the frequency count associated with highest ranked parent node in that particular classification or the node closest to the root nodes. For example, the weighting factor for SWIMMING POOL may have a SPECIFICITY of 500/100,000. Similarly, the SPECIFICITY for HEALTH CLUB is 10,000/100,000 and for POOL 1,000/100,000. The category of HEALTH is the first level beneath the root node in the classification or categorization tree 240 of FIG. 6.

It should be noted that any one of a variety of different techniques may be used in connection with determining a set of categories which are organized, for example, in a hierarchical or other configuration for use in performing categorization. It should also be noted that any one of a variety of different techniques may be used in determining a list of categories to use in the embodiments described herein. For example, one embodiment may determine a category list in accordance with a predetermined standard, such as the Standard Industry Classification (SIC) list of categories. Categories may also be manually and/or empirically determined.

Other embodiments may use other techniques in connection with determining weighting factors for each of the different categories that may vary in accordance with each embodiment as well as the representation and organization of the categories themselves. For example, an embodiment may use a first technique in connection with determining the weighting factor when using a hierarchical category arrangement and may utilize a second different technique in an embodiment in which a flat or non-hierarchical category structure is used.

It should also be noted that the documents which are searched and used may come from one or more sites or sources. For example, an embodiment may use or subscribe to the services of the query services from 112 which may use one set of documents to produce a list of categories. Additionally, the advertisement publication system 116 may perform another query in addition to using the services of the query server system 112 using a different set of documents. This different set of documents may be stored, for example, locally on the advertisement publication system 116, or alternatively, the advertisement publication system may subscribe to the services of more than one query server system to have multiple lists of documents.

Once the categories have been ranked, in one embodiment the list of categories and associated rankings may be sent from the term selection tool 204 to the advertisement registration system 200 for formation and arrangement into the form of an HTML page. The advertisement registration system 200 may then return this HTML page including the alternative suggested terms to the browser executing on the user system. The HTML page may then be displayed and the advertiser may select from the ranked categories one or more alternative terms to be associated with the advertisement.

As described elsewhere herein, depending on what the advertiser wishes to accomplish, the advertiser may select more general terms to be associated with their advertisement. For example, referring back to FIG. 8 representation 300, an advertiser having a swimming pool advertisement may select to have their advertisement associated with the broader term “pool”, without requiring the additional term “swimming”. This may give the advertisement greater exposure or possibility for display.

The advertiser may pay a particular price, for example, the more general the term, or the greater the number of terms that the advertiser selects to be associated with their particular advertisement to increase the chances of it being displayed to a user performing a query. The advertiser may use the information provided via the alternative suggested terms or categories to also select synonyms. A synonym of a term, for example, may not be hierarchically above the term. For example, if the advertiser initially enters the terms “swimming pool,” the advertiser may not wish to select “pool” or a broader category, but may alternatively select other phrases such as “hot tub” or “lap pool” to also be associated with their particular advertisement. Using the techniques described herein, an advertiser may select more general terms providing broader exposure of their advertisement, or, alternatively, may select more specific phrasing or synonyms, for example, that may occur at the same or lower level than the categorical tree arrangement.

Using the techniques described herein, the advertiser may cause the execution of the same processing steps as an end user searching for a restaurant or other particular service or product which displays the advertisement such as those entered by the advertiser through the system 116 using the techniques described herein.

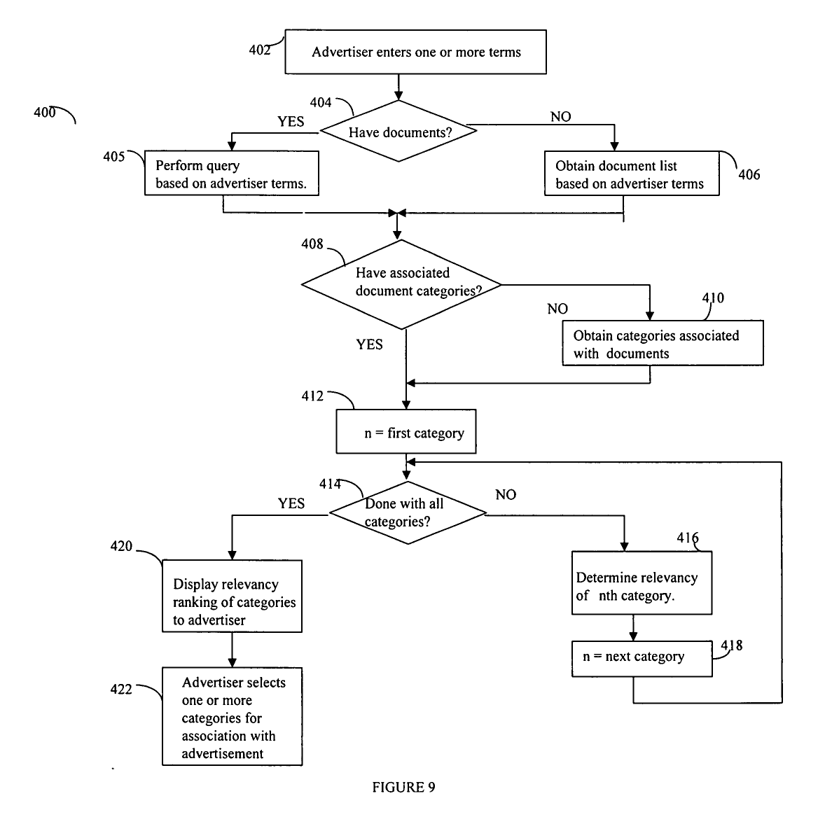

Referring now to FIG. 9, shown is a flowchart 400 of steps of one embodiment for producing a list of alternative suggestions to an advertiser. It should be noted that the processing steps of flowchart 400 summarize the steps described elsewhere herein. At step 402, the advertiser enters one or more terms. It should be noted that additionally the advertiser has selected to have alternative terms presented in connection with the advertisement terms supplied at step 402. At step 404, a determination is made as to whether the advertisement publication system needs to subscribe to the services of another server system using the documents maintained by that query server system, or alternatively, whether the advertisement publication system 116 will perform the query using its own documents, for example, on its own system. If at step 404 it is determined that the advertisement publication system 116 is going to use the query services and documents of another system, control proceeds to step 406 where the query is performed, for example, using the documents maintained by that system. In return, the advertisement publication system may receive the actual documents as part of step 406 depending on whether the advertisement publication system needs to also perform categorization.

If a determination is made at step 404 that the advertisement publication system 116 will perform its own query using its own document set, control proceeds to step 405 where the query is performed. As a result of executing step 405 or 406, the documents including the advertiser's specified terms have been determined.

At step 408, a determination is made as to whether the advertisement publication system 116 has the associated document categories. If so, control proceeds to step 412. Otherwise, control proceeds to step 410 where the categories associated with each of the documents are determined. Recall that, as described herein, any one of a variety of different techniques may be used in connection with determining the categories associated with each of the documents included the advertiser's supplied terms. At step 412, the local variable n is assigned the first category of all of those categories associated with the documents. At step 414, a determination is made as to whether all of the categories have been processed. If not, control proceeds to step 416 where the relevancy or ranking of the n^{th} category is determined. As described elsewhere herein, the relevancy or ranking of the n^{th} category may be determined using any one of a variety of different techniques, including those described herein as well as others known to those of ordinary skill in the art. Subsequently, control proceeds to step 418 where n is assigned to the next category of the documents determined to include the advertiser's terms, and control proceeds to step 414. This processing continues through each of the categories until, at step 414, it has been determined that all categories have been processed. When a yes determination is made at step 414 such that all categories have been processed, a relevancy factor or ranking has been determined for each of the categories associated with the documents that include the advertiser's terms entered at step 402. Subsequently, at step 420, the relevancy ranking of the categories may be displayed to the advertiser and at step 422 the advertiser may select one or more categories for association with their advertisement.

It should be noted that prior to executing step 420, an embodiment may perform selection of a subset of the categories that have just been ranked in accordance with the relevancy. For example, an advertiser may have selected an option to have the top 20 relevant categories displayed as alternative suggestions to the one or more terms entered at step 402. In this instance, the advertisement publication system 116 may include additional processing step prior to step 420 in which the categories are sorted by decreasing relevancy or ranking metric. Then the advertisement publication system selects a subset of the top m elements or categories where m may be determined, for example, in accordance with the advertiser specified parameter value as well as, for example, a default parameter value.

It should be noted that the format and contents of the suggested term alternatives may vary in accordance with each embodiment. Described elsewhere herein is a ranked list of categories that may be used as alternative terms associated with an advertisement. An embodiment may also display categories in accordance with one of the particular category structures, for example, of FIGS. 6 and/or 7. If the advertiser has indicated that they wish to associate the advertisement with a broader category that includes their one of more terms, the advertisement publication system 116 may display an HTML page that shows the broader category and other terms within that category. For example, if the advertiser's terms include “swimming pool”, this term may be associated with the terms “hot tub” and “lap pool” included in the same “pool” bucket category. The HTML page displayed may indicate the broader category of “pool” as well as the other related terms of the “pool” bucket. This may be used to communicate to the advertiser what additional terms will be associated with their advertisement if the advertiser elects to have the advertisement associated with the “pool” bucket category.

While the invention has been described and illustrated in connection with certain preferred embodiments, many variations and modifications as will be evident to those skilled in the art may be made therein without departing from the spirit of the invention, and the invention is thus not to be limited to the precise details of construction set forth above.

What is claimed is:

1. A method for selecting at least one term associated with display of an electronic advertisement comprising:
obtaining an initial search term;
obtaining a resultant set of one or more documents including said initial search term and categories associated with each of said documents in said resultant set; and
displaying a portion of said categories as possible candidates for said at least one term associated with display of said electronic advertisement.

2. The method of claim 1, further comprising:
searching a plurality of documents for said initial search term producing said resultant set.

3. The method of claim 2, wherein said searching is performed using a query tool.

4. The method of claim 3, wherein said query tool is located at a first network location and said obtaining an initial search term, said obtaining a resultant set, and said displaying a portion of said categories are performed in response to a request received at a second network location different from said first network location.

5. The method of claim 3, wherein said query tool is located at a first network location and said obtaining an initial search term, said obtaining a resultant set, and said displaying a portion of said categories are performed in response to a request received at said first network location.

6. The method of claim 1, further comprising:
categorizing said resultant set of documents.

7. The method of claim 6, wherein said categorizing is performed using at least one of: an automatic categorization tool located at a first network location and said obtaining an initial search term, said obtaining a resultant set, and said displaying a portion of said categories are performed in response to a request received at said first network location.

8. The method of claim 6, wherein said categorizing is performed using at least one of: an automatic categorization tool located at a first network location and said obtaining an initial search term, said obtaining a resultant set, and said displaying a portion of said categories are performed in response to a request received at a second network location different from said first network location.

9. The method of claim 1, wherein said portion of categories are broader than said initial search term, said initial search term being a subcategory within a first category included in said portion.

10. The method of claim 9, wherein said portion of categories are represented in a data structure including a first level with at least one main category having at least one subcategory, said first category being included in said at least one main category

11. The method of claim 10, wherein said one main category includes a plurality of subcategories and the method further comprising:
selecting at least one other of said plurality of subcategories as said at least one term to be associated with display of an electronic advertisement.

12. The method of claim 1, further comprising:
sending a request from a first computer to a second computer, wherein said obtaining an initial search term, said obtaining a resultant set, and said displaying a portion of said categories are performed in response to said request being received at said second computer, wherein a quantity of categories of said portion which are displayed are determined in accordance with a value included in said request.

13. The method of claim 1, further comprising:
ranking said portion of said categories.

14. The method of claim 13, wherein said ranking is determined in accordance with a relevancy metric associated with each category included in said portion.

15. The method of claim 14, wherein said relevancy metric of said each category is a value weighted in accordance with a count of a number of documents within which said category is associated.

16. The method of claim 15, wherein said relevancy metric is weighted in accordance with said count relative to a total number of other categories which are related to said each category.

17. The method of claim 16, wherein said category and said other categories have a hierarchical relationship to one another.

18. The method of claim 16, wherein said category and said other categories have a non-hierarchical relationship to one another.

19. The method of claim 16, wherein said relevancy metric is represented as:
COUNT*SPECIFICITY
where COUNT is said count and SPECIFICITY is 1/log(COUNT), log being the mathematical logarithmic function.

20. The method of claim 16, wherein said relevancy metric is represented as:
COUNT*SPECIFICITY
where COUNT is said count and SPECIFICITY is a ratio in which a numerator is COUNT and a denominator is an integer quantity of a total number of documents including said category and at least one related category.

21. The method of claim 1, wherein said portion of categories are related subcategories included within a same category.

22. A method for selecting at least one term associated with an electronic advertisement comprising:
issuing a request from a first computer to an advertisement publication system, said request including one or more initial advertisement terms;
providing to said first computer by said advertisement publication system a list of suggested alternatives to the one or more initial advertisement terms; and
selecting said at least one term from the suggested alternatives to be associated with the advertisement, wherein display of said electronic advertisement is determined in accordance with said at least one term selected.

23. The method of claim 22, further comprising determining the suggested alternatives.

24. The method of claim 23, further comprising performing, by the advertisement publication system:
obtaining a list of documents including the initial advertisement terms and the categories associated with the documents;
ranking the categories; and
selecting a portion of the categories as the suggested alternatives.

25. The method of claim 24, wherein the suggested alternatives include at least one of: a category including the initial advertisement terms as subcategories therein, and a related term in which the related term and the initial advertisement are subcategories within a same category.
